(19) United States
(12) Patent Application Publication
(10) Pub. No.: US 2020/0341474 A1
(43) Pub. Date: Oct. 29, 2020

(54) METHOD AND DEVICE FOR GENERATING AN AUTONOMOUS DRIVING TRAJECTORY OF A VEHICLE

(71) Applicant: WeRide Corp., Sunnyvale, CA (US)

(72) Inventor: Zhiyuan ZUO, Sunnyvale, CA (US)

(21) Appl. No.: 16/391,343

(22) Filed: Apr. 23, 2019

(51) Int. Cl. G05D 1/02; G05D 1/00; B60W 30/09; B60W 30/095

(52) U.S. Cl. CPC G05D 1/0214; G05D 1/0088; G05D 2201/0213; B60W 30/0953; B60W 30/0956; B60W 30/09

(57) ABSTRACT

A method and device for generating an autonomous driving trajectory of a vehicle are provided. The method comprises: acquiring information of an external environment wherein the vehicle is currently traveling; defining an envelope based on the information of the external environment, wherein the envelope defines a predicted travelable region of the vehicle in a subsequent predetermined time period; generating a reference path for the subsequent predetermined time period based on the envelope; and modifying the reference path based on a current lateral state of the vehicle or a road marker within the external environment, so as to generate the autonomous driving trajectory of the vehicle.

### TECHNICAL FIELD

The present disclosure generally relates to automotive technology, more particularly, to a method and device for generating an autonomous driving trajectory of a vehicle.

### BACKGROUND

Autonomous driving is a relatively new technological field for automotive industry. With autonomous driving, vehicles are capable of sensing their environment and navigating without human operations. To do so, information of the vehicles' external environment is considered by planning module to generate a safe and smooth trajectory to feed into the vehicle control module. During the foresaid trajectory generating process, a reference path is usually required. Various methods for generating or designing the reference path are provided in the art. Many of these methods involve a step of searching a specific reference path among a plurality of candidate paths using path planning algorithms. As shown in FIG. 1A, a plurality of candidate paths 103 are firstly generated for vehicle 101. After that, a reference path is then determined by searching among the candidate paths 103 using path planning algorithms. This process usually involves high energy and time consumption, and introduces higher CPU and memory requirements on the device conducting the process.

Thus, there is a need for further improvement in generating an autonomous driving trajectory of a vehicle.

### SUMMARY

According to a first aspect of embodiments of the present disclosure, a method for generating an autonomous driving trajectory of a vehicle is provided. The method may include: acquiring information of an external environment wherein the vehicle is currently traveling; defining an envelope based on the information of the external environment, wherein the envelope defines a predicted travelable region of the vehicle in a subsequent predetermined time period; generating a reference path for the subsequent predetermined time period based on the envelope; and modifying the reference path based on a current lateral state of the vehicle or a road marker within the external environment, so as to generate the autonomous driving trajectory of the vehicle.

According to a second aspect of embodiments of the present disclosure, a device for generating an autonomous driving trajectory of a vehicle is provided. The device may include: a processor; and a memory for storing instructions executable by the processor; wherein the processor is configured to: acquire information of an external environment wherein the vehicle is currently traveling; define an envelope based on the information of the external environment, wherein the envelope defines a predicted travelable region of the vehicle in a subsequent predetermined time period; generate a reference path for the subsequent predetermined time period based on the envelope; and modify the reference path based on a current lateral state of the vehicle or a road marker within the external environment, so as to generate the autonomous driving trajectory of the vehicle.

According to a third aspect of embodiments of the present disclosure, a non-transitory computer-readable storage medium is provided. The non-transitory computer-readable storage medium may have stored therein instructions that, when executed by a processor, causes the processor to perform a method for generating an autonomous driving trajectory of a vehicle, wherein the method comprising: acquiring external environment information of the vehicle; defining an envelope based on the external environment information of the vehicle, wherein the envelope defines a travelable region of the vehicle; generating a reference path based on the envelope; and modifying the reference path to generate the autonomous driving trajectory of the vehicle.

It is to be understood that both the foregoing general description and the following detailed description are exemplary and explanatory only, and are not restrictive of the invention. Further, the accompanying drawings, which are incorporated in and constitute a part of this specification, illustrate embodiments of the invention and together with the description, serve to explain principles of the invention.

### BRIEF DESCRIPTION OF THE DRAWINGS

The drawings referenced herein form a part of the specification. Features shown in the drawing illustrate only some embodiments of the disclosure, and not of all embodiments of the disclosure, unless the detailed description explicitly indicates otherwise, and readers of the specification should not make implications to the contrary.

FIG. 1A depicts a schematic diagram of a reference path determining process in accordance with the prior art.

FIG. 1B depicts a representative autonomous driving system.

FIG. 2 depicts a flow chart of a process of generating an autonomous driving trajectory of a vehicle according to one embodiment of the present disclosure;

FIG. 3 depicts a schematic diagram of an envelope for generating an autonomous driving trajectory of a vehicle according to one embodiment of the present disclosure;

FIG. 4 depicts a flow chart of a process associated with the process of FIG. 2;

FIG. 5 depicts a schematic diagram of a reference path generated according to one embodiment of the present disclosure;

FIG. 6 depicts another schematic diagram of a reference path generated according to one embodiment of the present disclosure;

FIG. 7 depicts another schematic diagram of a reference path generated according to one embodiment of the present disclosure;

FIG. 8 depicts a schematic diagram of a device for generating an autonomous driving trajectory of a vehicle according to one embodiment of the present disclosure;

FIG. 9 depicts a vehicle mounted with the device of FIG. 8;

FIG. 10 depicts a schematic diagram of an envelope for generating an autonomous driving trajectory of a vehicle according to one embodiment of the present disclosure.

The same reference numbers will be used throughout the drawings to refer to the same or like parts.

### DETAILED DESCRIPTION OF THE PREFERRED EMBODIMENTS

The following detailed description of exemplary embodiments of the disclosure refers to the accompanying drawings that form a part of the description. The drawings illustrate specific exemplary embodiments in which the disclosure may be practiced. The detailed description, including the drawings, describes these embodiments in sufficient detail to enable those skilled in the art to practice the disclosure. Those skilled in the art may further utilize other embodiments of the disclosure, and make logical, mechanical, and other changes without departing from the spirit or scope of the disclosure. Readers of the following detailed description should, therefore, not interpret the description in a limiting sense, and only the appended claims define the scope of the embodiment of the disclosure.

In this application, the use of the singular includes the plural unless specifically stated otherwise. In this application, the use of “or” means “and/or” unless stated otherwise. Furthermore, the use of the term “including” as well as other forms such as “includes” and “included” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

Autonomous Driving System

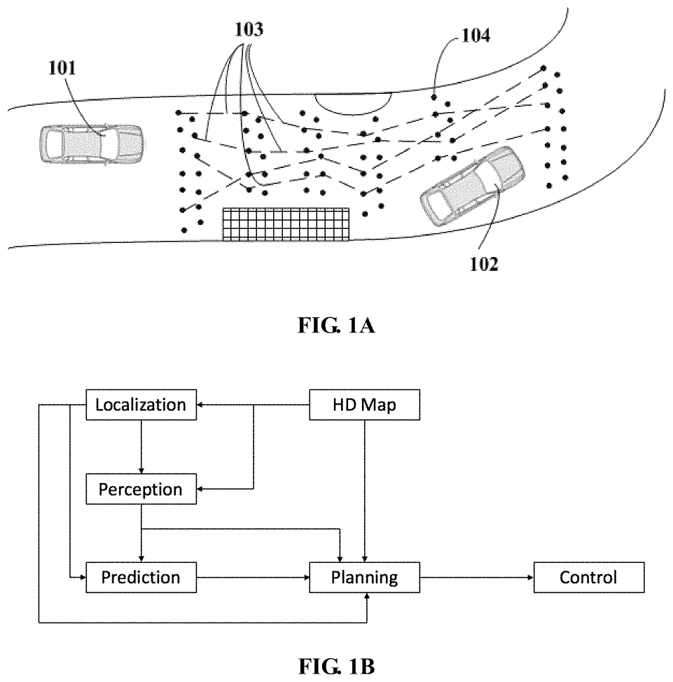

Autonomous vehicles (also known as driverless cars, self-driving cars or robot cars) are capable of sensing its environment and navigating without human input. Autonomous vehicle is a complex system integrating many technologies that coordinate to fulfill the challenging task of controlling a vehicle without human input. FIG. 1B illustrates an exemplary autonomous vehicle system that comprises functional subsystems, or modules, that work collaboratively to generate signals for controlling a vehicle.

Referring to FIG. 1B, an autonomous vehicle system includes a high definition (HD) map that the autonomous vehicle can use to plan its path. A HD map used by an autonomous vehicle contains a huge amount of driving assistance information. The most important information is the accurate 3-dimensional representation of the road network, such as the layout of the intersection and location of signposts. The HD map also contains a lot of semantic information, such as what the color of traffic lights means, the speed limit of a lane and where a left turn begins. The major difference between the HD map and a traditional map is the precision—while a traditional map typically has a meter-level precision, the HD map requires a center-meter level precision in order to ensure the safety of an autonomous vehicle. The HD map dataset may be stored in the autonomous vehicle. Alternatively, the HD map dataset is stored and updated in a server (e.g., a cloud) that communicates with the autonomous vehicle and provides the map information necessary for the autonomous vehicle to use.

The information in the HD map is used by many other modules of the autonomous driving system. In the first place, a localization module depends on the HD map to determine the exact location of the autonomous vehicle. The HD map also helps a perception module to sense the environment around the autonomous vehicle when the surrounding area is out of the range of the sensors or blocked by an obstacle. The HD map also helps a planning module to find suitable driving space and to identify multiple driving routes. The HD map allows the planning module to accurately plan a path and choose the best maneuver.

A localization module of the autonomous driving system helps an autonomous vehicle to know where exactly it is, which is a challenging task because any single sensor or instrument currently available, such as GPS and IMU, is insufficient to provide location information accurately enough for autonomous driving. Current localization technology uses information gathered by the sensors installed in the autonomous vehicle to identify landmarks in the surrounding environment and determines the location of the autonomous vehicle relative to the landmarks. The localization module then compares the landmarks identified by the sensors to the corresponding landmarks in the HD map, thereby determining the exact location of the autonomous vehicle in the map. Typically, to ensure a localization of high precision required by autonomous driving, a localization module combines information collected by multiple sensors using different localization techniques, such as GNSS RTK (Global Navigation Satellite System Real-time Kinematics) used by GPS, inertial navigation used by IMU, LiDAR localization and visual localization.

A perception module of the autonomous driving system is configured to sense the surrounding of the autonomous vehicle using sensors such as camera, radar and LiDAR and to identify the objects around the autonomous vehicle. The sensor data generated by the sensors are interpreted by the perception module to perform different perception tasks, such as classification, detection, tracking and segmentation. Machine learning technologies, such as convolutional neural networks, have been used to interpret the sensor data. Technologies such as Kalman filter have been used to fuse the sensor data generated by different sensors for the purposes of accurate perception and interpretation.

Many of the objects around the autonomous vehicle are also moving. Therefore, a prediction module of the autonomous driving system is configured to predict the behavior of these moving objects in order for the autonomous vehicle to plan its path. Typically, the prediction module predicts the behavior of a moving object by generating a trajectory of the object. The collection of the trajectories of all the objects around the autonomous vehicle forms a prediction of a timestep. For each timestep, the prediction module recalculates the prediction for every moving object around the autonomous vehicle. These predictions inform the autonomous vehicle to determine its path.

A planning module of the autonomous driving system incorporates the data from the HD map module, localization module and prediction module to generate a trajectory for the vehicle. The first step of planning is route navigation that generates a navigable path. Once a high-level route is built, the planning module zooms into trajectory planning, which makes subtle decisions to avoid obstacles and creates a smooth ride for the passengers, i.e., to generate a collision-free and comfortable trajectory to execute.

The trajectory generated in the planning module is then executed by a control module to generate a series of control inputs including steering, acceleration and/or braking. Several conditions need be considered by the control module when generating control inputs. First, the controller needs to be accurate so that the result avoid deviation from the target trajectory, which is important for safety. Second, the control strategy should be feasible for the car. Third, comfortable driving is important for the passenger. Hence the actuation should be continuous and avoid sudden steering, acceleration or braking. In sum, the goal of the controlling module is to use viable control inputs to minimize deviation from the target trajectory and maximize passenger comfort.

Exemplar Embodiments

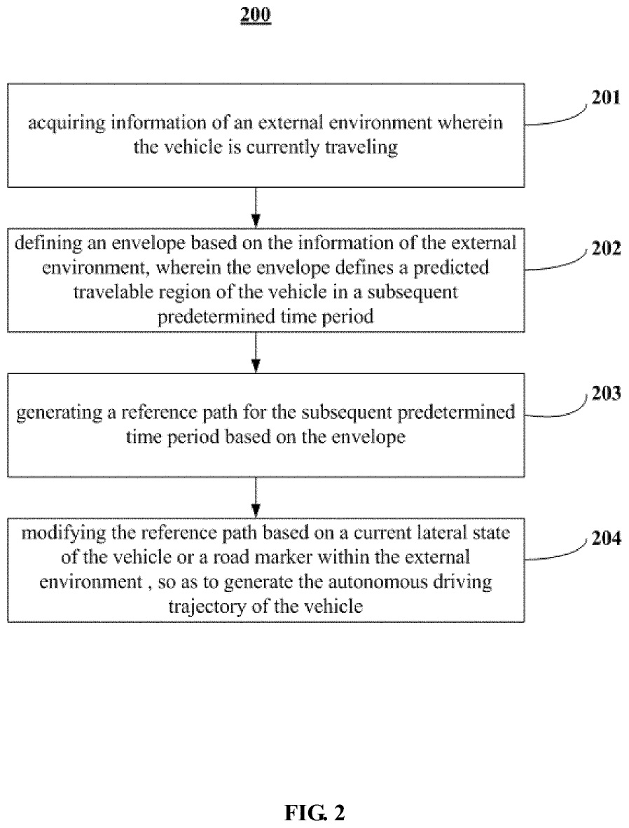

FIG. 2 depicts a flow chart of a process of generating an autonomous driving trajectory of a vehicle according to one embodiment of the present disclosure. Referring to FIG. 2, in step 201, information of an external environment is acquired as the vehicle is currently traveling.

The information of external environment may include any information within a region, such as a section of road, wherein the vehicle is currently traveling. In some embodiments, the information of the external environment includes information of an obstacle, information of a road or combination thereof. Specifically, the information of the external environment may include types, positions, size, moving speeds, acceleration speeds and/or moving directions of one or more obstacles on a road or a section of the road wherein the vehicle is currently traveling in. The information of a road may include road markers, traffic signs, pavement conditions and/or boundaries of the road or a section of the road. In some instances, only the information of the obstacles in the road section and the boundaries of the road section are obtained. However, it should be noted that any other types of information that is indicative of the external environment of the road section, wherein the vehicle is currently traveling, can also be obtained in step 201.

In one aspect, the information of the external environment may include real-time detection information, pre-stored information or combination thereof.

The pre-stored information may be any information of the external environment that is previously acquirable. For example, the pre-stored information may include information of fixed obstacles within the environment, such as types, positions and/or size of one or more fixed obstacles on a road or a section of the road wherein the vehicle is currently traveling in. In some instances, the pre-stored information may include information of a map of the external environment, which includes road markers, traffic signs, pavement conditions and boundaries of the road on which the vehicle is currently traveling. In some instances, the pre-stored information is previously stored in a memory of the vehicle. In other instances, the pre-stored information is stored in a server in communication with the vehicle.

The real-time detection information may be any specific type of information of the external environment, which is detectable by the vehicle. In some instances, the real-time detection information may be motion conditions of one or more moving obstacles in the external environment, such as moving speeds, acceleration speeds and/or moving directions of one or more obstacles on a road or a section the road wherein the vehicle is currently traveling in. There are numerous ways to detect information of the external environment and the disclosure is not limited to any specific one of them. In some embodiments, the information of the external environment is detected by a sensor system, which have one or more sensors that are configured to detect information about the environment in which the vehicle travels. The sensor system is described in detail below.

In step 202, an envelope is defined based on the foresaid types of information of the external environment. The envelope defines a predicted travelable region of the vehicle in a subsequent predetermined time period. For example, if the envelope is a predicted travelable region within a road section in the subsequent 10 seconds, that means the vehicle is movable to any position within the envelope without colliding with any obstacles in the road section, going beyond any road boundaries of the road section or violating any traffic regulations, such as entering into a lane for non-motorized vehicle of the road section, in the subsequent 10 seconds. The envelope is also called as a preview range of the vehicle. A length of the preview range depends on the speed of the vehicle. For example, the length of the preview range is 50 meters when the vehicle is traveling with a low speed (e.g. 20-40 km/h). In addition to the foresaid types of information of the external environment, the envelope is defined further in consideration of other factors. In some instances, the ride comfort of the vehicle is considered, by excluding some regions with bad pavements within the envelope. In some instances, the envelope is defined further in consideration of a movement condition of the vehicle itself in addition to the foresaid information of the external environment. The moving condition of the vehicle may include positions, moving speeds, acceleration speeds and/or moving directions of the vehicle, which may be obtained by sensors or sensor system as mentioned before.

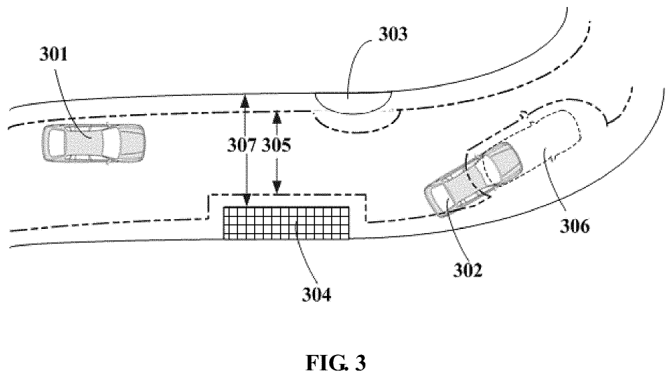

Referring to FIG. 3, an envelope 305 for generating an autonomous driving trajectory of vehicle 301 according to one embodiment of the present disclosure is illustrated. As shown in FIG. 3, vehicle 301 is traveling in a road section, in which there are fixed obstacles 303, 304 and moving vehicle 302. A dash line box 306 refers to a predicted occupancy region of the moving vehicle 302 in a subsequent predetermined time period. It is defined based on the current position and moving conditions of the moving vehicle 302, such as a moving speed and heading of the moving vehicle 302. In some instances, the moving condition of vehicle 301 is also considered in determining the dash line box 306 of the moving vehicle 302. It is can be seen that, envelope 305 defines a region having a contour generally along the outlines of obstacles 303, 304, the dash line box 306 and road boundaries of the road section. In some other instances, envelope 305 may be generated according to different rules. In some instances, the envelope 305 is generated further in consideration of other factors or information of the road section.

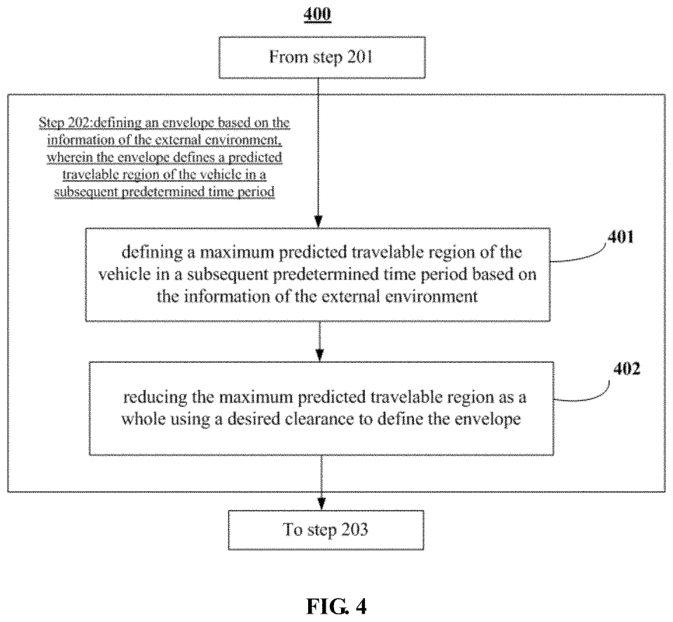

FIG. 4 depicts a flowchart of an example process 400 directed to defining an envelope associated with the process 200 of FIG. 2. The process 400 is corresponding to the step 202 of the process, which provide a specific method for defining an envelope.

In step 401, a maximum predicted travelable region of the vehicle in a subsequent predetermined time period is determined based on the information of the external environment received in step 201. The maximum predicted travelable region of the vehicle is a maximum region for the vehicle to move within while avoiding colliding or violating any traffic regulations in a subsequent predetermined time period. Referring to FIG. 3, 307 is a maximum predicted travelable region of vehicle 301. Similar to envelope 305, the maximum predicted travelable region 307 has a contour generally along the outlines of obstacles 303, 304, the dash line box 306 and road boundaries of the road section. In some other instances, the maximum predicted travelable region 307 may be generated according to different rules. In step 402, the maximum predicted travelable region is reduced as a whole using a desired clearance to define the envelope. Referring to FIG. 3, the maximum predicted travelable region 307 is reduced as a whole using a desired clearance to define the envelope 305. The desired clearance is an intervening space or distance between the maximum predicted travelable region 307 and the envelope 305. By introducing the desired clearance, the envelope 305 is defined as a more safety travelable region allowing free travel. The desired clearance may related to the parameters of the vehicle itself, such as turning radius or tread. In some instances, the desired clearance is a constant amount, which is selected from 0.5 meter to 1.2 meter, preferably from 0.6 meter to 0.75 meter. However, in other instances, the desired clearance may varies along the contour of the maximum predicted travelable region. That is to say, the amount of the desired clearance may be different for different obstacles. For example, the desired clearance for a pedestrian can be 1.0 meter. In other instances, the desired clearance may become larger along the contour near moving obstacles, since these objects may suddenly move and may affect the safety of the vehicle. In some instances, the desired clearance is preset by the user of the vehicle. In some instances, the amount of the desired clearance may be different for different scenarios. For example, it will become smaller when the traffic of the road is heavy.

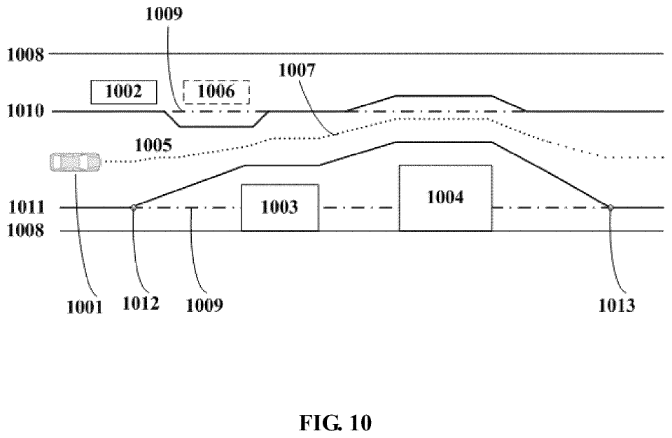

FIG. 10 depicts a schematic diagram of an envelope 1005 for generating an autonomous driving trajectory of a vehicle according to another embodiment of the present disclosure. As shown in FIG. 10, vehicle 1001 is traveling in a lane defined by lane markers 1009 within a road, in which there are fixed obstacles 1003, 1004 and moving obstacle 1002. Similar to the aforesaid dash line box 306, the dash line box 1006 in FIG. 10 refers to a predicted position of the moving obstacle 1002 in a subsequent predetermined time period. The envelope 1005 is generated in consideration of the lane markers 1009, the fixed obstacles 1003, 1004 and the predicted position 1006 of the moving obstacle 1002. A detailed process for generating the envelope 1005 is described with reference to FIG. 10.

Specifically, at a first step, the edges of the envelope 1005 is defined directly by the lane markers 1009. In some instances, the edges of the envelope 1005 is further defined in consideration of other road markers, such as a bus lane marker which indicates accesses of private vehicles may be inhibited during a certain time of the day.

At a second step, the edges of envelope 1005 is further modified so as to keep safety margin for fixed obstacles 1003, 1004 and moving obstacle 1002. It should be noted that, a portion of the envelope 1005 goes beyond the lane markers 1009, so as to keep a safety margin for obstacle 1004. In other words, keeping a safe margin for obstacles may have a higher priority than without overriding the lane markers in the process of generating an envelope. In some instances, a priority for each types of the obstacles and/or road markers are preset, and the envelope is generated further in consideration of the priority of each obstacles and/or road makers. For example, keeping a safety distances to a moving obstacles may have a higher priority than keeping safety distances to a fixed obstacles. In other instance, keeping a safety distances to a pedestrian enjoys a higher priority than keeping a distances to other obstacles.

After that, at least one veering points 1012, 1013 are further defined along the edges of the envelope 1005, and the edges of envelope 1005 are further modified in consideration of the veering points. The veering points 1012, 1013 are defined according to the size of the obstacles and the motion condition of the vehicle 1001, such as the moving speed, acceleration speed and/or moving direction of the vehicle 1001, so as to avoid harsh steering of the vehicle 1001. It should be noted that the sequences of the previously described steps may be changed, and this embodiment is not to limit the scope of the invention.

Referring back to FIG. 2, in step 203, a reference path for the subsequent predetermined time period is generated based on the envelope. The reference path is generated based on the envelope defined in step 202 and specific rules without help of time-consuming search-based path planning algorithms. Meanwhile, the driving continuity can easily be ensured by using this method.

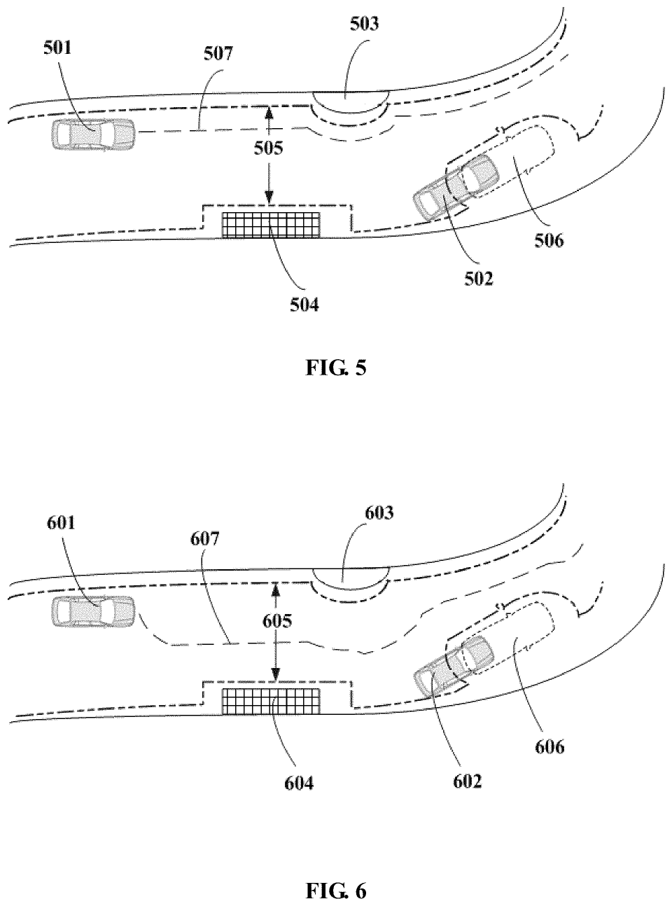

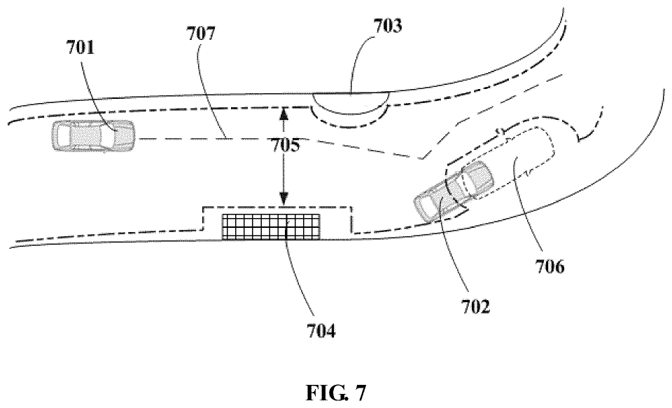

The rules for generating the reference path can be any rules containing a relationship between a reference path and an envelope, which can help define the reference path based on the envelope. FIG. 5, FIG. 6 and FIG. 7 illustrate reference paths generated according to different rules. Specifically, as shown in FIG. 5, the reference path 507 is generated along one side of a boundary of the envelope. For example, the reference path 507 is designed to make the distance between the reference path 507 and one side of the boundary of the envelope is constant, for example, in a distance from 0.5 meter to 1 meter. As shown in FIG. 6, the reference path 607 is generated along a central line along the envelope. Since the reference path 607 extends generally along the central line of the envelope, the vehicle 601 may have a sufficient safety margin from both sides of the envelope. Referring to FIG. 7, the reference 707 is defined to keep the vehicle 701 traveling straightly forward and move laterally only when the straight movement is not permitted, such as out of the envelope 707. In this way, the continuity of the driving can be well maintained.

Referring back to FIG. 2, in step 204, the reference path is modified based on a current lateral state of the vehicle or a road marker within the external environment, so as to generate the autonomous driving trajectory of the vehicle. In some instances, the current lateral state of the vehicle includes a heading of the vehicle or a lateral deviation from a central line of a road. For example, in consideration of the heading of the vehicle, the reference path generated in step 203 is modified so as to avoid emergency turn of the vehicle, which may affect the safety and comfort of passengers. In another example, the reference path is modified further in consideration of the deviation from a central line of a road, so as to avoid excessive deviation from the central line of the road. It should be noted that the road marker can be any road marker which indicating the traffic rules, and the reference path is modified so as to avoid violating any traffic regulations. In some instances, the reference path is modified based on a sign for an eversible lane, which indicates a specific travelable direction for a certain condition. In some instances, the reference path can also be modified based on the central line of a road the vehicle is current traveling on. Specifically, the reference path may be modified as to keep the deviation of the vehicle from a central line of the road within a certain limit. In some instances, the reference path can be modified based on other factors. For example, the reference path is modified to keep a larger distance away from a moving vehicle or obstacle, since these objects may suddenly move and may affect the safety of the vehicle.

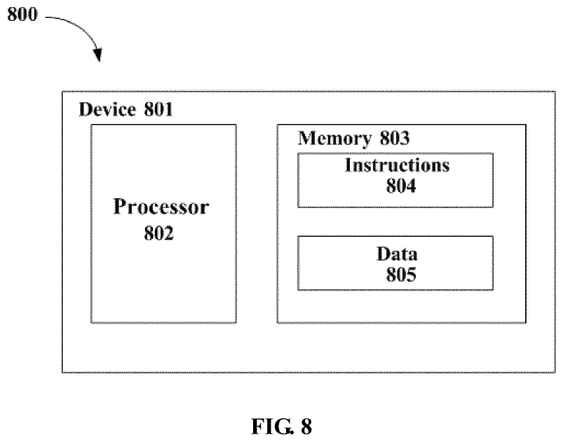

FIG. 8 depicts a schematic diagram of a device 801 for generating an autonomous driving trajectory of a vehicle according to one embodiment of the present disclosure. As shown in FIG. 8, the device 801 may include a processor 802 and a memory 803. The memory 803 of device 801 stores information accessible by the processor 802, including instructions 804 that may be executed by the processor 802. The memory 803 also includes data 805 that may be retrieved, processed or stored by the processor 802. The memory 803 may be of any type of tangible media capable of storing information accessible by the processor, such as a hard-drive, memory card, ROM, RAM, DVD, CD-ROM, write-capable, and read-only memories. The processor 802 may be any well-known processor, such as commercially available processors. Alternatively, the processor may be a dedicated controller such as an ASIC.

The instructions 804 may be any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. In some instances, the instructions 804 may be any set of instructions related to the processes 200 and 400 as described before.

Data 805 may be retrieved, stored or modified by processor 802 according to the instructions 804. For example, although the system and method are not limited by any particular data structure, the data may be stored in computer registers, in a relational database as a table having a plurality of different fields and records, or XML documents. The data may also be formatted in any computer-readable format such as, but not limited to, binary values, ASCII or Unicode. Moreover, the data may comprise any information sufficient to identify the relevant information, such as numbers, descriptive text, proprietary codes, pointers, references to data stored in other memories (including other network locations) or information that is used by a function to calculate the relevant data.

Although FIG. 8 functionally illustrates the processor and memory as being within the same block, the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

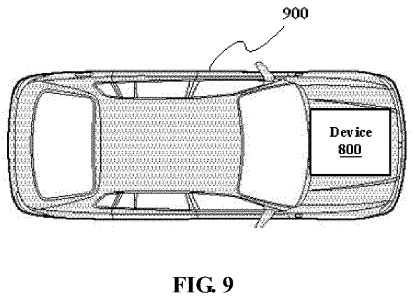

As shown in FIG. 9, the device 800 may be mounted on a vehicle 900, so as to control a motion of the vehicle 900. In some embodiment, the vehicle 900 is an autonomous driving vehicle. In some embodiments, besides the device 800, the vehicle 900 may further include certain common components which are included in ordinary vehicles, such as, an engine, wheels, steering wheel, transmission, etc., which may be controlled by the device 800 using a variety of communication signals and/or commands, such as, for example, acceleration signals or commands, deceleration signals or commands, steering signals or commands, braking signals or commands, etc.

In one aspect, the device 800 may have a sensor system for detecting the information of the external environment as mentioned above. The sensor system may include, but is not limited to, a camera, a global positioning system (GPS) unit, an inertial measurement unit (IMU), a radar unit, and a light detection and range (LiDAR) unit. In some embodiments, the camera may include one or more devices to capture images of the environment surrounding the autonomous vehicle. The camera may be a still camera or a video camera. The camera may be mechanically movable, for example, by mounting the camera on a rotating and/or tilting a platform. In some embodiments, the radar unit may utilize radio signals to sense objects within the local environment of the autonomous driving vehicle, or the radar unit may sense the speed and/or heading of the objects in addition to sensing objects. In some embodiments, the LiDAR unit may sense objects in the environment in which the autonomous driving vehicle is located using lasers. The LiDAR unit may include one or more laser sources, a laser scanner, and one or more detectors, among other system components. Since the GPS unit or the IMU unit can provide information regarding the positions and orientation changes of the autonomous vehicle 900 itself. The motion condition of the vehicle 900, which includes a current lateral state of the vehicle 900, is also acquirable by the device 800.

Furthermore, the device 800 may also include a wireless communication system that is configured to communication with external systems, such as devices, sensors, other vehicles and the like. In some embodiments, the wireless communication system can use a cellular communication network or a wireless local area network (WLAN) to communicate with one or more servers. The servers may be any kind of servers or a cluster of servers, such as Web or cloud servers, application servers, backend servers, or a combination thereof. For example, the servers may be a data analytics servers, content servers, traffic information servers, map and point of interest (MPOI) severs, or location servers, etc. In some embodiments, the wireless communication system could communicate directly with a device (e.g., a mobile device of a passenger, a display device, a speaker within the vehicle), for example, using an infrared link, Bluetooth, etc. By using the wireless communication system, the device 800 can also collect information from sensors mounted near a road, such as a camera mounted near the road. In addition, by using the wireless communication system, some foresaid pre-stored information in the server is also accessible by the device 800.

According to embodiments of the present disclosure, a reference path and a final driving trajectory for an autonomous vehicle can be generated much faster than the prior art, and the driving continuity can easily be ensured.

It should be noted that, the device and methods disclosed in the embodiments of the present disclosure can be implemented by other ways. The aforementioned device and method embodiments are merely illustrative. For example, flow charts and block diagrams in the figures show the architecture and the function operation according to a plurality of devices, methods and computer program products disclosed in embodiments of the present disclosure. In this regard, each frame of the flow charts or the block diagrams may represent a module, a program segment, or portion of the program code. The module, the program segment, or the portion of the program code includes one or more executable instructions for implementing predetermined logical function. It should also be noted that in some alternative embodiments, the function described in the block can also occur in a different order as described from the figures. For example, two consecutive blocks may actually be executed substantially concurrently. Sometimes they may also be performed in reverse order, depending on the functionality. It should also be noted that, each block of the block diagrams and/or flow chart block and block combinations of the block diagrams and/or flow chart can be implemented by a dedicated hardware-based systems execute the predetermined function or operation or by a combination of a dedicated hardware and computer instructions.

If the functions are implemented in the form of software modules and sold or used as a standalone product, the functions can be stored in a computer readable storage medium. Based on this understanding, the technical nature of the present disclosure, part contributing to the prior art, or part of the technical solutions may be embodied in the form of a software product. The computer software product is stored in a storage medium, including several instructions to instruct a computer device (may be a personal computer, server, or network equipment) to perform all or part of the steps of various embodiments of the present. The aforementioned storage media include: U disk, removable hard disk, read only memory (ROM), a random access memory (RAM), floppy disk or CD-ROM, which can store a variety of program codes.

Various embodiments have been described herein with reference to the accompanying drawings. It will, however, be evident that various modifications and changes may be made thereto, and additional embodiments may be implemented, without departing from the broader scope of the invention as set forth in the claims that follow.

Further, other embodiments will be apparent to those skilled in the art from consideration of the specification and practice of one or more embodiments of the invention disclosed herein. It is intended, therefore, that this disclosure and the examples herein be considered as exemplary only, with a true scope and spirit of the invention being indicated by the following listing of exemplary claims.

What is claimed is:

1. A method for generating an autonomous driving trajectory of a vehicle, the method comprising:
acquiring information of an external environment wherein the vehicle is currently traveling;
defining an envelope based on the information of the external environment, wherein the envelope defines a predicted travelable region of the vehicle in a subsequent predetermined time period;
generating a reference path for the subsequent predetermined time period based on the envelope; and
modifying the reference path based on a current lateral state of the vehicle or a road marker within the external environment, so as to generate the autonomous driving trajectory of the vehicle.

2. The method of claim 1, wherein the information of the external environment comprises real-time detection information, pre-stored information or combination thereof.

3. The method of claim 1, wherein the information of the external environment comprises information of an obstacle, information of a road or combination thereof.

4. The method of claim 3, wherein the envelope is generated further in consideration of a movement condition of the obstacle and the vehicle.

5. The method of claim 1, wherein the step of defining an envelope based on the information of the external environment comprises:
defining a maximum predicted travelable region of the vehicle in a subsequent predetermined time period based on the information of the external environment; and
reducing the maximum predicted travelable region as a whole using a desired clearance to define the envelope.

6. The method of claim 1, wherein the step of defining an envelope based on the information of the external environment comprises:
defining edges of the envelope by two or more road markers within the external environment;
modifying the edges of the envelope based on at least one obstacles within the external environments and a priority for each obstacles and road markers, so as to keep a safety distance from the obstacles;
defining at least one veering points along the edges of the envelope based on information of the obstacles and a movement condition of the vehicle;
modifying the edges of the envelope based on the veering points.

7. The method of claim 1, wherein the step of generating a reference path for the subsequent predetermined time period based on the envelope comprises:
generating the reference path along a central line along the envelope.

8. The method of claim 1, wherein the reference path is configured to keep the vehicle traveling straightly and to move laterally only if the straight movement will go beyond the envelope.

9. The method of claim 1, wherein the current lateral state of the vehicle comprises a heading of the vehicle or a lateral deviation from a central line of a road.

10. A device for generating an autonomous driving trajectory of a vehicle, the device comprising:
a processor; and
a memory for storing instructions executable by the processor;
wherein the processor is configured to:
acquire information of an external environment wherein the vehicle is currently traveling;
define an envelope based on the information of the external environment, wherein the envelope defines a predicted travelable region of the vehicle in a subsequent predetermined time period;
generate a reference path for the subsequent predetermined time period based on the envelope; and
modify the reference path based on a current lateral state of the vehicle or a road marker within the external environment, so as to generate the autonomous driving trajectory of the vehicle.

11. The device of claim 10, wherein the information of the external environment comprises real-time detection information, pre-stored information or combination thereof.

12. The device of claim 10, wherein the information of the external environment comprises information of an obstacle, information of a road or combination thereof.

13. The device of claim 12, wherein the envelope is generated further in consideration of a movement condition of the obstacle and the vehicle.

14. The device of claim 10, wherein the step of defining an envelope based on the information of the external environment comprises:
defining a maximum predicted travelable region of the vehicle in a subsequent predetermined time period based on the information of the external environment;
reducing the maximum predicted travelable region as a whole using a desired clearance to define the envelope.

15. The device of claim 10, wherein the step of generating a reference path for the subsequent predetermined time period based on the envelope comprises:
generating the reference path along one side of a boundary of the envelope, wherein a lateral distance between the reference path and the side of the boundary of the envelope is constant and the distance is from 0.5 meter to 1 meter.

16. The device of claim 10, wherein the step of generating a reference path for the subsequent predetermined time period based on the envelope comprises:
generating the reference path along a central line along the envelope.

17. The device of claim 10, wherein the reference path is configured to keep the vehicle traveling straightly and to move laterally only if the straight movement will go beyond the envelope.

18. The device of claim 10, wherein the current lateral state of the vehicle comprises a heading of the vehicle or a lateral deviation from a central line of a road.

19. A non-transitory computer-readable storage medium having stored therein instructions that, when executed by a processor, causes the processor to perform a method for generating an autonomous driving trajectory of a vehicle, wherein the method comprising:
acquiring external environment information of the vehicle;
defining an envelope based on the external environment information of the vehicle, wherein the envelope defines a travelable region of the vehicle;
generating a reference path based on the envelope; and
modifying the reference path to generate the autonomous driving trajectory of the vehicle.
